(19) United States
(12) Patent Application Publication
(10) Pub. No.: US 2015/0183179 A1
(43) Pub. Date: Jul. 2, 2015

(54) ARTICLE COMPRISING A TRANSPARENT BODY INCLUDING A LAYER OF A CERAMIC MATERIAL AND A METHOD OF FORMING THE SAME

(71) Applicant: Saint-Gobain Ceramics & Plastics, Inc., Worcester, MA (US)

(72) Inventor: John M. Frank, Hartville, OH (US)

(21) Appl. No.: 14/584,586

(22) Filed: Dec. 29, 2014

Related U.S. Application Data
(60) Provisional application No. 61/922,331, filed on Dec. 31, 2013.

(51) Int. Cl. B32B 3/02; B22D 19/00; B32B 18/00; B05D 3/00

(52) U.S. Cl. CPC B32B 3/02; B05D 3/002; B22D 19/0081; B32B 18/00; B32B 2307/412; B32B 2457/00

(57) ABSTRACT

A transparent body can include a layer of a ceramic material and a compound. The compound can fill a defect extending from an edge of the layer, seal the edge, or both. In an embodiment, the edge is ground and is not polished. The compound can help to keep defects from propagating, improve fracture toughness, and reduce the likelihood that a crack will form during subsequent fabrication or use of the transparent body. Thus, the transparent body can be more scratch resistant than glass, such as cover glass, and still have acceptable resistance to cracking. The transparent body can be formed using a method where a compound precursor solution is applied to the edge, and the compound precursor solution is reacted or cured to form the compound.

### CROSS-REFERENCE TO RELATED APPLICATION

The present application claims priority to U.S. Patent Application No. 61/922,331, filed Dec. 31, 2013, entitled “Article Comprising a Transparent Body Including a Layer of a Ceramic Material and a Method of Forming the Same”, naming as an inventor John M. Frank, which application is incorporated by reference herein in its entirety.

### FIELD OF THE DISCLOSURE

The present disclosure is directed to articles including a transparent body that includes a layer of a ceramic material and methods of forming the same.

### BACKGROUND

Cellular phones and other mobile electronic devices can have displays with a window that has an exposed surface. The layer at the exposed surface can be cover glass (also called “gorilla glass”), which is a glass that has a relatively higher alumina content than soda lime glass. The cover glass is less likely to be scratched than a polymer layer but is only slightly more resistant to scratching than soda lime glass, as the compositions of cover glass and soda lime glass are substantially similar. Continued improvement in windows with better scratch resistance is desired.

### BRIEF DESCRIPTION OF THE DRAWINGS

Embodiments are illustrated by way of example and are not limited in the accompanying figures.

FIG. 1 includes an illustration of a perspective view of a mobile electronic device including a frame and a display.

FIG. 2 includes an illustration of a top view of a transparent body.

FIG. 3 includes an illustration of a side view of the transparent body of FIG. 2 in accordance with an embodiment.

FIG. 4 includes an illustration of a side view of the transparent body of FIG. 2 in accordance with an embodiment.

FIG. 5 includes an illustration of a side view of the transparent body of FIG. 2 in accordance with an embodiment.

FIG. 6 includes an illustration of a side view of the transparent body of FIG. 2 in accordance with an embodiment.

FIG. 7 includes an illustration of a side view of the transparent body of FIG. 2 in accordance with an embodiment.

FIG. 8 includes a flow diagram for a method of forming a layer that can be used in the transparent body of FIG. 2 in accordance with an embodiment.

FIG. 9 includes an illustration of a side view of a cutting tool that can be used to form an edge along a side of a layer of ceramic material.

FIG. 10 includes an illustration of a side view of another cutting tool that can be used to form an edge along a side of a layer of ceramic material.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The term “ceramic material” is intended to mean a material that is substantially monocrystalline or polycrystalline. Ceramic material is not intended to mean a material that principally amorphous, such as glass.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

An article can include a transparent body that has a layer including a ceramic material, wherein the layer has an edge. The edge may not lie along a single plane. As used herein, not lying along a single plane is intended to mean that up to 80% of the distance along the edge between the major surfaces lies along a single plane. The article can further include a compound that fills a defect along the edge or seals the edge. In an embodiment, the article can be or include a window. The window may be part of a mobile computing device. The layer can have a hardness greater than cover glass and soda lime glass. In a particular embodiment layer can include a ceramic material, such as a sapphire (monocrystalline Al₂O₃), a spinel (monocrystalline MgAl₂O₄), aluminum oxynitride (AlxOyNz, wherein 1≦x<2, 0<y<3, and 0<z<1) (also called “AlON”), or the like. The compound that fills the defect or seals the edge can help to reduce and may substantially prevent the defect from further propagating, additional defects from forming along the edge, resulting in a crack or other mechanical or visible defect, or the like. Particular embodiments and benefits seen with such embodiments are better understood after reading the description in conjunction with the figures.

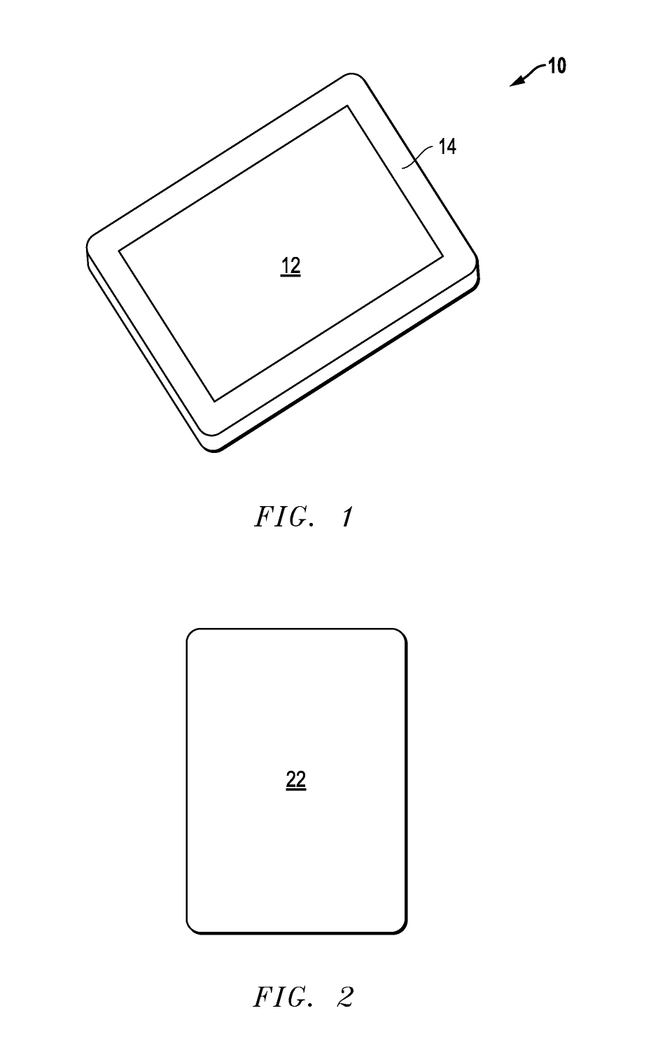

FIG. 1 includes an illustration of a perspective view of a mobile electronic device 10. The mobile electronic device 10 can be a cellular phone, a smartphone, a tablet computer, a netbook, a laptop computer, or the like. The mobile electronic device can include a display 12 and a housing 14. The display provides visual information to a user and includes a window along an exposed surface of the mobile electronic device 10. The display 12 can be attached to a frame (not illustrated) and electrically coupled to electronic components (not illustrated) within the housing 14. The mobile electronic device 10 can be easily transported by a human. In an embodiment, the mobile electronic device 10 can have a mass no greater than 2 kg, no greater than 1.4 kg, or no greater than 0.9 kg, no greater than 0.5 kg, or no greater than 0.3 kg. In another embodiment, the mobile electronic device 10 may have a mass of at least 0.011 kg, at least 0.02 kg, or at least 0.05 kg. In a particular application, the mobile electronic device is a cellular phone or a smartphone and has a mass in a range of 0.05 kg to 0.25 kg. In another particular application, the mobile electronic device is a tablet computer and has a mass in a range of 0.4 kg to 0.8 kg. In another embodiment, the mobile electronic device can have a mass that is greater than 2 kg.

FIG. 2 includes a top view of a transparent body 22 that can be used as the window for the display 12 of the mobile electronic device 10. The transparent body 22 can be used in other devices. The transparent body 22 can have relatively high transmission of visible light (>80% transmission) and relatively low haze (<3%). The transparent body 22 can be clear (that is, colorless) or may have a color, if needed or desired. In a particular embodiment, the transparent body 22 has a layer, wherein the layer has a pair of major surfaces along opposite sides of layer that are separated by one or more edges between the major surfaces. When the transparent body 12 is used as a window, the major surfaces may be referred to as faces. The transparent body 22 has a length and a width that correspond to the dimensions of the major surfaces, and a thickness that is the distance between the major surfaces and corresponds to the edge. Each of the length and width are substantially greater than the thickness.

The transparent body 22 can include a single layer or a plurality of layer. An exposed surface of the transparent body 22 may come in contact with keys, sand, or other materials. To reduce the likelihood of forming scratches, a layer can lie at the exposed surface, wherein the layer includes a ceramic material. In an embodiment, the ceramic material can include a material that is harder than cover glass, such as a sapphire (monocrystalline Al₂O₃), a spinel (monocrystalline MgAl₂O₄), aluminum oxynitride (AlₓO_{y}N_{z}, wherein 1≦x<2, 0<y<3, and 0<z<1) (also called “AlON”), or the like.

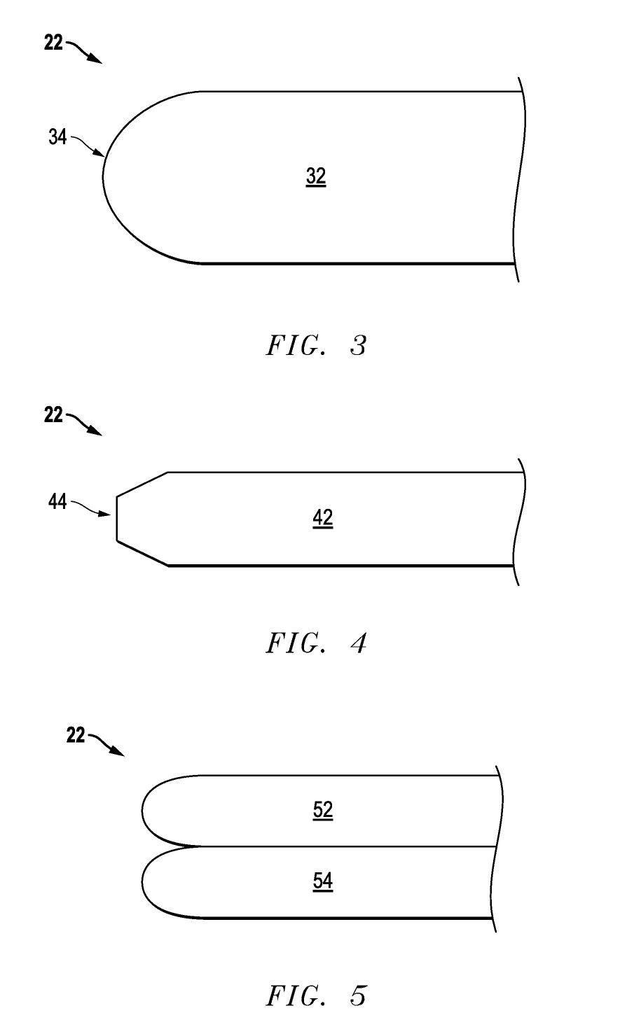

Ceramic materials can be susceptible to chipping, and thus, an edge of a layer of a ceramic material may be formed such that 90° angles are not formed between the edge and either or both of the major surfaces. Thus, the edge may not lie along a single plane between the major surfaces. FIG. 3 illustrates a cross-sectional view of a portion of the transparent body 22 that has only a single layer 32 of the ceramic material. In FIG. 3, the layer 32 has a rounded edge 34. The rounded edge can be a full radius or a partial radius. In a particular embodiment, the rounded edge is a full radius. In another embodiment, the rounded edge can be initially formed as a full radius and after further fabrication, such as grinding, lapping, or polishing the major surfaces, the rounded edge may be only a partial radius (not a full 180° curve). FIG. 4 includes an illustration of a cross-sectional view of another embodiment of the transparent body 22 in which a layer 42 of ceramic material has a faceted edge 44. Although the layer 42 has a surface along the edge that is substantially normal to the major surfaces, such surface of the edge spans a distance that is less than 80% of the distance between the major surfaces. In another embodiment, the edge can be beveled, chamfered, or the like adjacent to either or both major surfaces.

FIG. 5 includes an illustration of another embodiment in which the transparent body 22 includes a plurality of layers 52 and 54. The layer that will be exposed to the user, such as layer 52, can include the ceramic material. In an embodiment, the layers 52 and 54 can include the same material. In a particular embodiment, the layers 52 and 54 can include the same monocrystalline material having the same crystal orientation for the major surfaces and lengths of the edges (as seen in FIG. 2). For example, the layers 52 and 54 can include sapphire, have major surfaces substantially along the C-plane, the lengths of the horizontal edges substantially along the A-plane, and the lengths of the vertical edges substantially along the M-plane. In another embodiment, the layers 52 and 54 can include the same monocrystalline material and have major surfaces or edges lying substantially along different crystal planes. For example, the layer 52 may have major surfaces lying substantially along the C-plane, horizontal edges substantially along the A-plane, and the lengths of the vertical edges substantially along the M-plane, and the layer 54 may have major surfaces lying substantially along the C-plane, horizontal edges substantially along the M-plane, and the lengths of the vertical edges substantially along the A-plane.

In another embodiment, the layers 52 and 54 can have different compositions. In a particular embodiment, the upper layer 52 can include sapphire, and the layer 54 can include spinel or AlON. In a further particular embodiment, the layer 52 can include a ceramic material, and the layer 54 can include glass (for example, soda lime glass, cover glass, or another glass) or another transparent material that that not a ceramic material, such as a polycarbonate, a polyacrylate, or the like. Thus, if layer 54 is not exposed to the environment, a material that is significantly less expensive and less likely to crack than sapphire, spinel, or AlON may be used.

The layers 52 and 54 can have edges between the major surfaces that do not lie along a single plane. The edge can be rounded, as illustrated in FIG. 5, or have any of the other shapes as previously described.

The layers 52 and 54 are adhered to each other. In a particular embodiment, the major surfaces of the layers 52 and 54 are polished and directly contact each other. The layers 52 and 54 has no significant amount of gas between the major surfaces that contact each other, and thus the layers 52 and 54 are not easily separated. Such a configuration may help to reduce a waveguide effect along the interface between the layers 52 and 54, particularly when the layers 52 and 54 have the same composition.

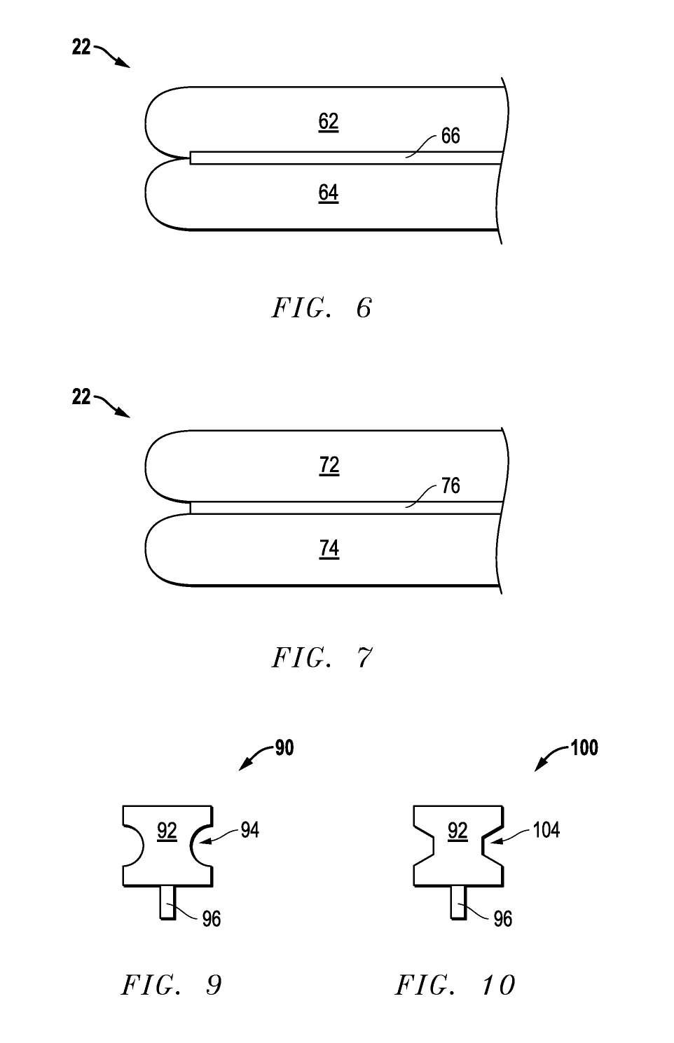

FIG. 6 includes an illustration of another embodiment of the transparent body 62 in which layers 62 and 64 are adhered to each other along a region 66. The layers 62 and 64 can have any of the compositions and shapes as previously described. In an embodiment, a portion of the layer 62 or 64 or portions of both layers 62 and 64 are locally melted to form the region 66 that holds the layers 62 and 64 together. In another embodiment, a material different from either or both of the layers 62 and 64 is placed between the layers 62 and 64 and taken at least to the plastic or melting point of such different material to form the region 66. The different material can be in the form of a frit, a powder, or a solid sheet of a material that can be melted. Such different material can include a glass or a transparent material.

FIG. 7 includes an illustration of another embodiment of the transparent body 62 in which layers 72 and 74 are adhered to each other using an adhesive 76 that is optically clear. The layers 72 and 74 can have any of the compositions and shapes as previously described. The adhesive 76 can be applied to either or both layers 72 and 74. The adhesive layer 76 can be pressure sensitive adhesive or can be cured.

In further embodiments, more layers can be used to for the transparent body 22. After reading this specification, skilled artisans will be able to determine whether a single layer or a plurality of layers should be used for their particular application. If needed or desired, materials and crystal orientations, if applicable, can be selected to achieve desired optical properties.

While the prior configurations have edges that do not lie along a single plane, such edges are typically formed by grinding and are not polished because the surface of the edge is non-planar or does not have a sufficient thickness to allow the edge to be polished. In an embodiment, the major surfaces are polished, so that the likelihood that a defect will be introduced along a polished surface is very low. Unlike the major surfaces, the edge may have a defect, and such defect can be manifested by forming a crack.

A ceramic material with a defect or flaw on a major surface or edge can have lower fracture toughness and are more susceptible to cracking. Defects can include scratches, chips, or marks in the surface of the ceramic material or anything that does not allow the ceramic material to meet a specification. A flaw can include a crack or inclusion within a body of the ceramic material. The defects and flaws can be macroscopic or microscopic in nature and may be difficult to inspect for. The defect or flaw substantially reduces the stress required to initiate and propagate a crack in the ceramic material. The defects and flaws can be introduced before, during, or after formation of the edge. Thus, the fabrication method in forming the layer (for example, grinding, lapping, polishing of the major surfaces, annealing, etc.), forming a composite for a transparent body, assembling a transparent body into a display, a mobile electronic device or other product, or use of such product can result in propagation of defects and flaws due to handling or fabrication or operating conditions (for example, thermal gradients across the transparent body).

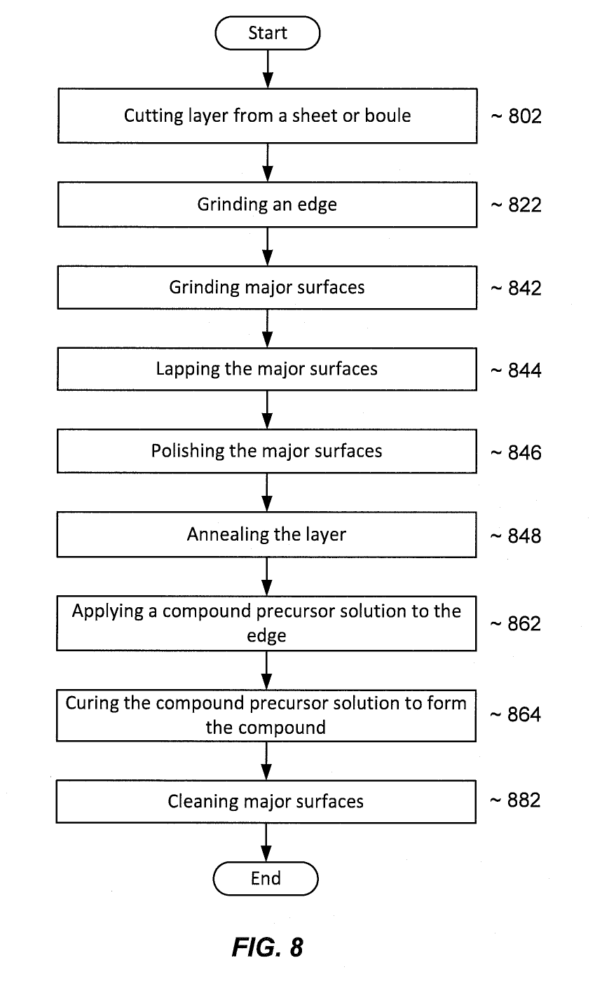

To reduce the likelihood that defects along the edges will result in cracks, fracture, or other undesired consequences, a defect along an edge can be filled, an edge can be sealed, or both may be performed to reduce the likelihood that a defect will lead to an undesired consequence. The method is better understood in view of the process flow as described below with reference to FIG. 8. A transparent body can include a single layer or plurality of layers. The process flow will be described with respect to a layer. The method can be iterated for other layers as needed to form layers that make up the transparent body. The actual method used may vary based on the material used for the layer.

The method can include cutting a layer from a sheet or boule, at block 802 of FIG. 8. When the layer includes a monocrystalline material, such as sapphire, spinel, or the like, the sheet can be formed using an edge-defined film-fed growth (“EFG”) or Stephenson process, and the boule can be formed by a Czochralski, Kyropolis, Bridgman or other technique. The layer can be cut from the sheet or boule. Cutting can be formed using a saw, a water jet, a laser, or the like. When the layer includes a polycrystalline material, the layer can be formed from one or more powders. The one or more powders are pressed into a shape and densified at a very high temperature (typically greater than 1000° C.) to form a densified body with low porosity (less than 5 volume %). The densified body can have the desired shape for the layer at this point in the method or may be cut to the desired shape. Cutting the shape can leave the edge surface essentially complete, and the edge in this case may be left in the as-cut state. Other methods can be used to generate the layer.

The method can include grinding an edge, at block 822. The layer may have one or more edges that are to be ground. Grinding can be performed using a fixed abrasive. Referring to FIG. 9, a cutting tool 90 can include a body 92, a surface 94 at which abrasive particles are attached, and a stem 96. The stem can be attached to a rotation source, such as a motor. The surface 94 has a complement of the desired shape of the edge. The cutting tool 90 can be used to form the edge 34 as seen in FIG. 3. The abrasive particles can include a material harder than the layer. In a particular embodiment, the material of the abrasives can include diamond, silicon carbide, cubic boron nitride, or the like. In another embodiment as illustrated in FIG. 10, a cutting tool 100 can include a surface 104 that can be used to form the edge 44 as seen in FIG. 4. In another embodiment, the edge 44 may be formed using more than one cutting tool or may be formed using more than one pass through the cutting tool. After reading this specification, skilled artisans will be able to determine how to form the edge for the layer. In an embodiment, the abrasive particles in the cutting tool have average particle size of 2 to 300 microns, and in a more particular embodiment, in a range of 10 to 100 microns. In an embodiment, the edge has an average surface roughness of at least 0.025 micron, at least 0.11 micron, at least 0.2 micron, or at least 0.3 micron, and in another embodiment, the average surface roughness is no greater than 3 microns, no greater than 2.5 microns, no greater than 2 microns, or no greater than 1.5 microns. In a particular embodiment, the average surface roughness is in a range of 0.025 micron to 3 microns, 0.11 micron to 2.5 microns, 0.2 micron to 2 microns, or 0.3 micron to 1.5 microns.

The major surfaces can be finished. The method can include grinding the major surfaces, at block 842 of FIG. 8. Generally, the grinding process removes a sufficient amount of material to remove major surface irregularities that may have occurred when initially forming the layer and to control flatness and thickness, at a reasonably high material removal rate, such as with a Blanchard grinder. Similar to grinding the edge, grinding can use a fixed abrasive that includes any of the previously described abrasive particles. In an embodiment, the abrasive particles have average particle size of 2 to 300 microns, and in a more particular embodiment, in a range of 10 to 100 microns. In an embodiment, after grinding, each of the major surfaces has an average surface roughness of at least 0.05 micron, at least 0.11 micron, at least 0.2 micron, or at least 0.3 micron, and in another embodiment, the average surface roughness is no greater than 3 microns, no greater than 2.5 microns, no greater than 2 microns, or no greater than 1.5 microns. In a particular embodiment, the average surface roughness is in a range of 0.05 micron to 3 microns, 0.11 micron to 2.5 microns, 0.2 micron to 2 microns, or 0.3 micron to 1.5 microns.

The method can further include lapping the major surfaces at block 844. Lapping can remove material to substantially remove defects generated during grinding. Lapping can help to provide a smoother surface before polishing. Lapping can be performed with loose abrasive particles instead of a fixed abrasive. The average particle sized used for grinding (block 842) is at least 10 microns and usually at least 20 microns greater than the average particle sized used for lapping. In an embodiment, the abrasive particles used for lapping have an average particle size of 2 to 50 microns, and in a more particular embodiment, in a range of 5 to 35 microns. After lapping, the major surfaces can have an average surface roughness Rₐ of less than about 0.10 microns, such as less than about 0.05 microns. In another embodiment, lapping may be replaced by grinding using a finer abrasive than used for during grinding described with respect to block 842. Lapping is optional, and in another embodiment, lapping is not preformed.

The method can further include polishing the major surfaces at block 846. Polishing can be preformed using a slurry having particles. The particles can include silica, zirconia, silicon carbide, boron carbide, diamond, or the like. The particles can have an average diameter or width no greater than 1000 nm, and more usually less then 200 nm, such as in a range of 10 to 150 nm. In an embodiment, polishing is performed as chemical-mechanical polishing. The polishing slurry may include water and one or other chemicals. For ceramic materials, the polishing is usually performed with a slurry having a pH greater than 7, and in a particular embodiment, the pH is at least 8 or 9. A chemical in the polishing slurry can react with the exposed major surface to form a polishing product that is removed by the particles and a polishing pad used during polishing. After polishing, in one embodiment, the major surfaces can have average surface roughness of at least 0.2 nm, at least 0.2 nm, at least 0.5 nm, at least 2 nm, or at least 3 nm, and in another embodiment, the average surface roughness is no greater than 9 nm, no greater than 8 nm, no greater than 7 nm, or no greater than 6 nm. In a particular embodiment, the average surface roughness is in a range of 0.1 nm to 9 nm, 0.2 nm to 8 nm, 0.5 nm to 7 nm, or 2 nm to 6 nm.

The method can further include annealing the layer at block 848. The grinding, lapping, polishing or any combination thereof can cause significant strain to build within the layer. The layer can be annealed at a temperature at or above 1000° C. for several hours. The anneal may be performed between any of the operations in blocks 822 to 846. Thus, the anneal does not need to be performed after polishing but may precede polishing. In another embodiment, more than one anneal may be performed, such as after lapping and after polishing. After reading this specification, skilled artisans will be able to determine the number of anneal and when an anneal is performed for their particular application.

The foregoing operations that have been described can generate defects or cause defects to propagate. Because the major surfaces are polished, they should be relatively free of defects. Unlike the major surfaces, the edge is not polished because the edge has a non-planar surface or the thickness so not sufficiently thick to allow it to be polished. Therefore, a defect is more likely to be present that extends from the edge to a point within the layer. Such a defect can be propagating during handling of the layer, the subsequent fabrication operations to make a finished product, or when a finished product is in use. An example of what can happen during use can include cyclic fatigue crack propagation, in which tension-compression cycles are applied to a body, wherein each cycle generates stress that is lower than the critical stress required to exceed the critical value and cause the crack to run. In cyclic propagation, applications of small amounts of stress can cause a crack to grow very slowly until it reaches a critical length, at which point it will run. Such tension-compression cycles can occur when a person places a cellular phone is his or her back pocket then sits down or when a tablet computer in placed in a backpack with heavier items, such as books, and the backpack is set down or carried causing weight to shift onto the tablet computer. The defect may be filled with a compound, the edge may be sealed by a compound, or both may be performed to improve the fracture toughness of the layer.

The method can include applying a compound precursor solution to the edge at block 862. The compound precursor solution will form a compound along the edge and may extend from a defect into the edge. The compound can be optically clear as the layer will used to form the transparent body or part of a transparent body. If need or desired for a particular application, the compound may have a refractive index close to the refractive of the layer. Components for the compound precursor solution may be selected for a particular application. The compound precursor solution can include an adhesive, a sealant, a hardener, an elastomer, or a combination thereof. In a particular embodiment, the compound precursor solution can include an epoxy resin, a cyanoacrylate resin, a methacrylate resin, a silicone resin, a polyol, an isocyanate, or any combination thereof. In a more particular embodiment, the compound precursor solution can include an epoxy silane, a glyicidylepoxy compound, a bisphenol compound, a cyanoacrylic compound, a methacrylic compound, an acrylonitrile compound, or any combination thereof. A hardener can include at least two terminal groups having an epoxide moiety. In a combination of resin and hardener, the hardener can be in a range of 2 mol % to 30 mol % of the combination. When filling a defect, the hardener may be no greater than 10 mol % of the combination, so that the compound does not set up too fast. When sealing the edge, the hardener may be at least 12 mol % of the combination, so that the compound sets up relatively faster, as compared to filling a defect. In an embodiment, the hardener is in a range of 8 to 15 mol % of the combination.

The compound precursor solution can further include other components that may assist with the coating or provide properties that reduce the likelihood of aging or discoloration of the compound. In an embodiment, the compound precursor solution includes a solvent, a surfactant, a wetting agent, a UV absorber, a radical scavenger, or any combination thereof. In a particular embodiment, the solvent, surfactant, wetting agent, or the like can help with the flow characteristics of the compound precursor solution.

For example, when filling a defect, relatively low surface density may allow the compound precursor solution to flow better into a defect. In an embodiment, the compound precursor solution includes a solvent having a surface tension in air at a temperature of 20° C. of no greater than 99 mJ/m, no greater than 73 mJ/m, no greater than 50 mJ/m, or no greater than 40 mJ/m. In a particular embodiment, water has a surface tension in air at a temperature of 20° C. of approximately 72 mJ/m. Many organic solvents have surface energy densities below 72 mJ/m. For example, many unsubstituted aliphatic hydrocarbon compounds with 12 or less carbon atoms, alcohols with 10 or less carbon atoms, ethers and ketones with 6 or less carbon atoms, and unsubstituted aryl compounds have surface tensions in air at a temperature of 20° C. no greater than 30 mJ/m. Substituting one or more H atoms with a halide, particularly an F atom, and further reduce the surface energy density as compared to the unsubstituted compound. In another embodiment, the compound precursor solution includes a solvent having a surface tension in air at a temperature of 20° C. of at least 15 mJ/m, at least 20 mJ/m, at least 25 mJ/m, or at least 30 mJ/m. In a particular embodiment, the compound precursor solution includes a solvent having a surface tension in air at a temperature of 20° C. in a range of 15 mJ/m to 99 mJ/m, 20 mJ/m to 73 mJ/m, 25 mJ/m to 50 mJ/m, or 30 mJ/m to 40 mJ/m.

When the compound is to seal the edge, the compound precursor solution may have a viscosity sufficiently high enough to allow the compound precursor solution to be maintained along the edge while the compound sufficiently solidifies or hardens. In an embodiment, the compound precursor has a dynamic viscosity at a temperature of 25° C. of at least 5 cP, at least 30 cP, at least 50 cP, or at least 110 cP. In another embodiment, the compound precursor solution has a dynamic viscosity at a temperature of 25° C. no greater than 20,000 cP, no greater than 9000 cP, no greater than 2000 cP, or no greater than 900 cP. In a particular embodiment, the compound precursor solution may have a dynamic viscosity at a temperature of 25° C. no greater than 2000 cP to allow more readily the compound precursor flowing into the defect. In another particular embodiment, the compound precursor solution has a dynamic viscosity at a temperature of 25° C. in a range of 5 cP to 20,000 cP, 30 cP to 9000 cP, 50 cP to 2000 cP, or 110 cP to 900 cP.

The compound precursor solution can be applied by dispensing it along the edge or along either or both major surfaces. In a particular embodiment, the compound precursor solution can be applied by dispensing the compound precursor solution on the edge or on the major surface adjacent to the edge when the layer is moving relative to the dispensing stream. In another embodiment, the compound precursor solution can be spin coated by dispensing the compound precursor solution near the center of a major surface and increasing the spin speed to control the thickness of the compound precursor solution. In another embodiment, the compound precursor solution can be applied using a brush, a sponge, or another applicator. The applicator may move, the layer may move, or both the applicator and layer can move during application.

The thickness of the compound precursor solution applied to the edge may depend on whether the compound precursor solution is being used to fill a defect along the edge or seal the edge. In an embodiment, a portion of the edge may be exposed after the application if a defect is being filled. In another embodiment, substantially all of the edge may be covered when the edge is being sealed. Accordingly, the compound precursor solution may be applied over a wide range of thicknesses. If a desired thickness is not obtained, the compound precursor solution can be applied one or more additional times to achieve a desire thickness. A final thickness of the compound is addressed further later in this specification.

The method can further include curing the compound precursor solution to form the compound at block 864. After the compound precursor solution is applied, the compound is formed by reaction, curing, or the like. In a particular embodiment, the compound is formed from the reaction of a resin and a hardener within the compound precursor solution. In this embodiment, the resin and hardener are combined shortly before applying the compound precursor solution to the edge. In another embodiment, the compound precursor solution is cured by light, such as visible light, ultraviolet radiation, or the like. In a further embodiment, the compound precursor solution is cured with heat, such as exposure to room temperature (22° C.) or a higher temperature, such as in a range of 25° C. to 200° C., or in a more particular embodiment, in a range of 35° C. to 100° C. The previously described methods of causing the compound to form are merely exemplary and are not intended to limit how the compound is formed.

After reaction, curing or the like, the compound can include a polyether, a polyacrylate, or a polysiloxane. A polyether can be formed from an epoxy. In an embodiment, the compound can be a beta-hydroxypolyether or polyalkylacrylate. In a particular embodiment, the polyether is substantially free of nitrogen atoms. In another embodiment, the polyacrylate can be a polycyanoacrylate, such as a polycyanoalkylacrylate, or a polymethylacrylate. In a particular embodiment, other than cyano groups, the polyacrylate is substantially free of nitrogen atoms. In still another embodiment, the compound can be polyalkylsiloxane. Alkyl groups in the foregoing compounds may have 1 to 4 carbon atoms.

The average thickness of the compound along the edge can vary depending on the application. At one end of the spectrum, the average thickness along the edge can be substantially 0 microns, as only defects may be filled and substantially none of the compound lies along the edge. At the other end of the spectrum, the average thickness along the edge may be very easy to detect just be a visible inspection. Such an average thickness may be useful in sealing the edge. Although there is no theoretical upper limit on the thickness, the average thickness of the compound along the edge is typically no greater than 900 microns. In an embodiment, the average thickness is at least 0.1 micron, at least 1 micron, at least 2 microns, or at least 5 microns, and in another embodiment, the average thickness is no greater than 200 microns, no greater than 90 microns, no greater than 50 microns, or no greater than 20 microns. In a particular embodiment, the average thickness of the compound along the edge is in a range of 0.1 micron to 200 microns, 1 micron to 90 microns, 2 microns to 50 microns, or 5 microns to 20 microns.

The method can further include cleaning the major surfaces at block 882. Some of the compound precursor solution may have also been applied to one or both of the major surfaces. The compound, residue from the compound precursor solution, or particles or other contamination may be on one or both of the major surfaces. The major surfaces can be cleaned to remove any compound, residue, particles, or other contamination from the major surfaces. The cleaning can be performed by rinsing the major surfaces with water or an organic compound, scrubbing the major surfaces with a polymer felt pad or brushes, placing the layer in an agitated bath (for example, an ultrasonic or megasonic bath), exposure to an etchant (for example, an oxygen-containing or fluorine-containing plasma, a solvent that can dissolve or soften the compound or residue), another suitable cleaning method that does not scratch or adversely affect the optical properties of the major surfaces, or any combination thereof. When an etchant is used, skilled artisans should be careful to remove the compound or residue from the major surfaces while removing little, if any, of the compound along the edge. In another embodiment, a very short touch-up polish may be performed. Such a polish will be performed with significantly less downforce pressure than the polishing operation described with respect to block 862. None or no more than a few nm of the layer may be removed during the touch-up polish. If needed or desired, a film may be applied to either or both major surfaces to cover the major surfaces before the compound precursor solution is applied to the edge. The film may obviate or substantially simplify the cleaning process. For example, after the compound is formed, the film can be removed, and the cleaning may only involve removing an adhesive that was used to keep the film on the major surface.

At this point in the method, the layer has been prepared for the transparent body 22. If the transparent body includes a plurality of layers, another layer can be prepared for the transparent body. The next layer can include the same or different ceramic material as the prior layer. In another embodiment, the next layer can include a vitreous layer such as a glass (for example, soda lime glass, cover glass, or the like). The next layer can be processed using some or all of the operations as previously described for the prior layer. When the layer includes glass, grinding, lapping, polishing, or any combination thereof may be performed. The abrasives used for grinding, lapping, or both may use abrasive particles that are of the same or less hardness than the abrasive particle used for the ceramic material. For polishing, the composition of the polishing slurry can depend on the material being polished. For example, polishing an aluminum-containing material may use a phosphorous-containing slurry, and polishing a silicon-containing material may use a hydroxide-containing slurry.

The compound previously described may be used to fill a defect in the next layer, seal an edge of the next layer, or both. After all layers of the transparent body 22 have been prepared, the layers can be adhered to each other. If needed or desired, sealing the edges of the layer may be performed after the transparent body 22 is formed. In a particular embodiment, a compound can be used to seal defects in each layer before layers are adhered to each other, and sealing with the same or a different compound is performed after the layers are adhered to each other. In another particular embodiment, none or not all of the layers have defects filled, and sealing is performed after the layers are adhered to each other. After reading this specification, skilled artisans will be able to determine how to fill defects or seal layers to meet the needs or desires for a particular application.

In a further embodiment, a layer of the transparent body 22 may further include a layer that does not need to have a edge ground, a defect that needs to be filled or an edge that does not need to be sealed. For example, the layer can be a polymer layer or a sheet of previously finished glass.

The transparent body 22 can include a composite of layers. After the layers have been processed or obtained, the layers can adhered to each other as previously described.

The transparent body 22, whether in the form of a single layer or a composite, can be a finished product. In another embodiment, a bezel or frame can be formed or placed around the transparent body 22 after a defect in the transparent body has been filled. In an embodiment, an injection molding technique can be use to form the frame. The transparent body 22 can be placed into a mould for injection molding. In a particular embodiment, liquid or molten metal can be injected into the mould and fill a cavity in the mould that is not occupied by the transparent body 22. The metal can be an alloy. In a more particular embodiment, the metal can be Liquidmetal Alloy™ (Liquidmetal Technologies of Rancho Santa Margarita, Calif., USA). In another embodiment, a thermoset or thermoplastic resin may be injected instead of the metal. In a further embodiment, a metal bezel or frame can be placed around the transparent body 22, and a thermoset or thermoplastic resin may be injected to fill a void between the metal bezel or frame and the transparent body 22.

In a further application, the transparent body 22 can be combined with other components to form a finished product. For example, the transparent body 22 can be attached to a frame of a mobile electronic device. In another embodiment, the transparent body 22 can be attached to a display as a sub-assembly that can be installed within a mobile electronic device or other apparatus. The transparent body 22 can be oriented before attachment so that the surface that is exposed to a user has layer of a ceramic layer to reduce the likelihood of scratching the window.

While ceramic materials can be harder than and more scratch resistant that glass, including cover glass, such materials may also be more susceptible to cracking. Because the polished surfaces of the layer should not have a significant defect that would cause cracking, controlling defects along the edge can help to reduce the likelihood that the layer will subsequently crack during processing of the layer or during subsequent fabrication or use of the layer. The methods described above can be used to fill a defect along an edge of a layer, seal an edge of the layer, or both. The compound used to fill the defect or seal the edge can reduce the likelihood that the defect along the edge will continue to propagate. The compound can also increase the fracture toughness of the layer bringing the fracture toughness closer to a pure defect free material. Thus, a layer of ceramic material can be more likely to withstand the rigors of fabrication and use without the layer cracking or exhibiting an adverse property that can affect the mechanical or optical properties of the layer.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Item 1. An article including a transparent body including a first layer including a first ceramic material, wherein the first layer has an edge that does not lie along a single plane; and a compound that fills a defect along the edge.

Item 2. An article including a transparent body including a first layer including a first ceramic material, wherein the first layer has an edge that does not lie along a single plane, wherein a defect lies along or extends into the edge; and a compound that seals the edge.

Item 3. An article including a transparent body including a first layer including a first ceramic material, wherein the first layer first layer has a length of at least 1.1 cm, a width of at least 1.1 cm, and a thickness no greater than 1 mm, wherein an edge of the first layer corresponds to the thickness; and a compound that fills a defect along the edge.

Item 4. An article including a transparent body including a first layer including a first ceramic material, wherein the first layer first layer has a length of at least 1.1 cm, a width of at least 1.1 cm, and a thickness no greater than 1 mm; an edge of the first layer corresponds to the thickness; and a defect lies along or extends into the edge. The transparent body can further include a compound that seals the edge.

Item 5. A method of forming an article including a transparent body, the method including grinding a first layer including a first ceramic material to form an edge that does not lie along a single plane; applying a compound precursor solution to the edge of the first layer; and curing the compound precursor solution to form a compound, wherein the transparent body includes the first layer.

Item 6. A method of forming an article, the method including providing a transparent body including a first layer including a first ceramic material, wherein the first layer first layer has a length of at least 1.1 cm, a width of at least 1.1 cm, and a thickness no greater than 1 mm; grinding a first layer including a first ceramic material to form an edge corresponding to the thickness of the first layer, wherein after grinding, a defect lies along or extends into the edge; applying a compound precursor solution to the edge; and curing the compound precursor solution to form a compound.

Item 7. The article or the method of any one of the preceding Items, wherein the first layer has a first major surface and a second major surface opposite the first major surface, wherein the edge is disposed between the first and second major surfaces.

Item 8. The article or the method of any one of Items 3, 4, 6, and 7, wherein the edge does not lie along a single plane.

Item 9. The method of any one of Items 5 to 8, further including filling with the compound precursor solution a defect along the edge.

Item 10. The method of any one of Items 5 to 9, further including sealing with the compound precursor solution the edge.

Item 11. The method of any one of Items 5 to 10, wherein the compound precursor solution includes a solvent having a surface tension at a temperature of 20° C. no greater than 99 mJ/m, no greater than 73 mJ/m, no greater than 50 mJ/m, or no greater than 40 mJ/m.

Item 12. The method of any one of Items 5 to 11, wherein the compound precursor solution includes a solvent having a surface tension in air at a temperature of 20° C. of at least 15 mJ/m, at least 20 mJ/m, at least 25 mJ/m, or at least 30 mJ/m.

Item 13. The method of any one of Items 5 to 12, wherein the compound precursor solution includes a solvent having a surface tension in air at a temperature of 20° C. in a range of 15 mJ/m to 99 mJ/m, 20 mJ/m to 73 mJ/m, 25 mJ/m to 50 mJ/m, or 30 mJ/m to 40 mJ/m.

Item 14. The method of any one of Items 5 to 13, wherein the compound precursor solution has a dynamic viscosity at a temperature of 25° C. of at least 5 cP, at least 30 cP, at least 50 cP, at least 110 cP.

Item 15. The method of any one of Items 5 to 14, wherein the compound precursor solution has a dynamic viscosity at a temperature of 25° C. no greater than 20,000 cP, no greater than 9000 cP, no greater than 2000 cP, or no greater than 900 cP.

Item 16. The method of any one of Items 5 to 15, wherein the compound precursor solution has a dynamic viscosity at a temperature of 25° C. in a range of 5 cP to 20,000 cP, 30 cP to 9000 cP, 50 cP to 2000 cP, or 110 cP to 900 cP.

Item 17. The method of any one of Items 5 to 16, wherein the compound precursor solution includes an adhesive, a sealant, a hardener, an elastomer, or a combination thereof.

Item 18. The method of any one of Items 5 to 17, wherein the compound precursor solution includes an epoxy resin, an cyanoacrylate resin, a methacrylate resin, a silicone resin, a polyol, an isocyanate, or any combination thereof.

Item 19. The method of any one of Items 5 to 18, wherein the compound precursor solution includes an epoxy silane, a glyicidylepoxy compound, a bisphenol compound, a cyanoacrylic compound, a methacrylic compound, an acrylonitrile compound, or any combination thereof.

Item 20. The method of any one of Items 5 to 19, wherein the compound precursor solution further includes a solvent, a surfactant, a wetting agent, a UV absorber, a radical scavenger, or any combination thereof.

Item 21. The method of any one of the preceding Items, wherein the compound includes a polyether, a polyacrylate, or a polysiloxane.

Item 22. The method of any one of the preceding Items, wherein the compound includes a polyalkylether, a beta-hydroxypolyether, a polycyanoacrylate, a polyalkylacrylate, or silicon rubber.

Item 23. The method of any one of Items 7 to 22, further including removing a portion of the compound that lies along the first major surface.

Item 24. The method of Item 23, further including removing a portion of the compound that lies along the second major surface.

Item 25. The method of any one of Items 7 to 24, further including forming a first film along the first major surface before coating the edge with the compound precursor; and removing the first film after coating the edge with the compound precursor.

Item 26. The method of Item 25, further including forming a second film along the second major surface before coating the edge with the compound precursor; and removing the second film after coating the edge with the compound precursor.

Item 27. The method of any one of Item 7 to 26, further including polishing the first major surface.

Item 28. The method of Item 27, further including polishing the second major surface.

Item 29. The method of Item 27 or 28, wherein grinding the edge is performed before polishing the first major surface.

Item 30. The method of any one of Items 7 to 29, further including grinding the first major surface.

Item 31. The method of Item 30, further including grinding the second major surface.

Item 32. The method of Item 30 or 31, wherein grinding the first major surface is performed before polishing the first major surface.

Item 33. The method of any one of Items 7 to 32, further including lapping the first major surface.

Item 34. The method of Item 33, further including lapping the second major surface.

Item 35. The method of Item 33 or 34, wherein lapping the first major surface is performed before polishing.

Item 36. The method of any one of Items 5 to 35, further including annealing the first layer after grinding the first layer to form the edge and before coating the edge.

Item 37. The method of any one of Items 5 to 36, further including adhering a second layer to the first layer, wherein the transparent body includes the first and second layers.

Item 38. The method of Item 37, wherein adhering is performed without an adhesive.

Item 39. The method of Item 37 or 38, wherein adhering is performed without fusing the first layer and the second layer to each other; or fusing the first layer or the second layer to a different layer that is a part of the transparent body.

Item 40. The article or the method of any one of the preceding Items, wherein the compound fills the defect and seals the edge.

Item 41. The article or the method of any one of the preceding Items, wherein the first major surface of the first layer has a first side, a second side, and a rounded corner between the first and second sides.

Item 42. The article or the method of any one of the preceding Items, wherein the edge is a ground edge.

Item 43. The article or the method of any one of the preceding Items, wherein the edge is rounded.

Item 44. The article or the method any one of Items 1 or 42, wherein the edge is faceted.

Item 45. The article or the method of any one of Items 7 to 44, wherein the first major surface has a first average surface roughness, and the edge has a second average surface roughness that is greater than the first roughness.

Item 46. The article or the method of Item 45, wherein the second average surface roughness is at least 0.05 micron, at least 0.11 micron, at least 0.2 micron, or at least 0.3 micron.

Item 47. The article or the method of Item 45 or 46, wherein the second average surface roughness is no greater than 3 microns, no greater than 2.5 microns, no greater than 2 microns, or no greater than 1.5 microns.

Item 48. The article or the method of any one of Items 45 to 47, wherein the second average surface roughness is in a range of 0.05 micron to 3 microns, 0.11 micron to 2.5 microns, 0.2 micron to 2 microns, or 0.3 micron to 1.5 microns.

Item 49. The article or the method of any one of Items 45 to 48, wherein the first average surface roughness is at least 0.2 nm, at least 0.2 nm, at least 0.5 nm, at least 2 nm, or at least 3 nm.

Item 50. The article or the method of any one of Items 45 to 49, wherein the first average surface roughness is no greater than 9 nm, no greater than 8 nm, no greater than 7 nm, or no greater than 6 nm.

Item 51. The article or the method of any one of Items 45 to 50, wherein the first average surface roughness is in a range of 0.1 nm to 9 nm, 0.2 nm to 8 nm, 0.5 nm to 7 nm, or 2 nm to 6 nm.

Item 52. The article or the method of any one of the preceding Items, wherein the ceramic material is polycrystalline.

Item 53. The article or the method of any one of Items 1 to 51, wherein the ceramic material is monocrystalline.

Item 54. The article or the method of any one of the preceding Items, wherein the ceramic material includes a sapphire, a spinel, a mullite, a polycrystalline alumina, a yttria, a garnet, or any combination thereof.

Item 55. The article or the method of any one of the preceding Items, wherein the transparent body is substantially clear.

Item 56. The article or the method of any one of the Items 1, 2, and 5 to 55, wherein the first layer has a length of at least 1.1 cm, a width of at least 1.1 cm, and a thickness no greater than 1 mm, and the edge corresponds to the thickness.

Item 57. The article or the method of any one of Items 3 to 56, wherein the thickness is at least 0.05 mm, at least 0.08 mm, or at least 0.11 mm.

Item 58. The article or the method of any one of Items 3 to 57, wherein the thickness is no greater than 0.9 mm, no greater than 0.7 mm, or no greater than 0.5 mm.

Item 59. The article or the method of any one of Items 3 to 58, wherein the thickness is in a range of 0.05 mm to 1 mm, 0.08 mm to 0.9 mm, or 0.11 mm to 0.7 mm.

Item 60. The article or the method of any one of Items 3 to 59, wherein the length is at least 2 cm, at least 5 cm, or at least 10 cm.

Item 61. The article or the method of any one of Items 3 to 60, wherein the length is no greater than 60 cm, no greater than 50 cm, or no greater than 40 cm.

Item 62. The article or the method of any one of Items 3 to 61, wherein the length is in a range of 1.1 cm to 60 cm, 2 cm to 50 cm, or 5 cm to 40 cm.

Item 63. The article or the method of any one of Items 3 to 62, wherein the width is at least 2 cm, at least 3 cm, or at least 5 cm.

Item 64. The article or the method of any one of Items 3 to 63, wherein the width is no greater than 30 cm, no greater than 25 cm, or no greater than 20 cm.

Item 65. The article or the method of any one of Items 3 to 64, wherein the width is in a range of 1.1 cm to 30 cm, 2 cm to 25 cm, or 3 cm to 20 cm.

Item 66. The article or the method of any one of Items 7 to 65, wherein the first and second major surfaces are substantially free of the compound.

Item 67. The article or the method of any one of Items 1 to 42 and 46 to 66, wherein the transparent body further includes a second layer.

Item 68. The article or the method of Item 67, wherein the second layer includes a second ceramic material.

Item 69. The article or the method of Item 68, wherein the first ceramic material is different from the second ceramic material.

Item 70. The article or the method of Item 67, wherein the first and second layers have substantially a same composition.

Item 71. The article or the method of Item 67, wherein the second layer includes a vitreous material.

Item 72. The article or the method of any one of Items 43 and 67 to 71, wherein the transparent body further includes an adhesive layer between the first and second layers.

Item 73. The article or the method of any one of Items 43 and 67 to 71, wherein the transparent body does not include an adhesive layer between the first and second layers.

Item 74. The article or the method of any one of Items 43, 44, 67 to 71, and 73, wherein the first and second layers are fused together.

Item 75. The article or the method of any one of Items 43 and 67 to 73, wherein the first and second layers are not fused together.

Item 76. The article or the method of any one of the preceding Items, wherein the article consists essentially of the transparent body and the compound.

Item 77. The article or the method of any one of the preceding Items, wherein the article is a mobile electronic device, and wherein the transparent body is part of or covers a display of the mobile electronic device.

Item 78. The article or the method of Item 77, wherein the mobile electronic device has a mass no greater than 2 kg, no greater than 1.4 kg, or no greater than 0.9 kg, no greater than 0.5 kg, or no greater than 0.3 kg.

Item 79. The article or the method of Item 77 or 78, wherein the mobile electronic device has a mass of at least 0.11 kg, at least 0.02 kg, or at least 0.05 kg.

Item 80. The article or the method of any one of Items 77 to 79, wherein the mobile electronic device has a mass in a range of 0.05 kg to 0.25 kg, or 0.4 kg to 0.8 kg.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An article comprising:
a transparent body comprising a first layer including a first ceramic material, wherein the first layer has an edge that does not lie along a single plane, wherein a defect lies along or extends into the edge; and
a compound that fills the defect or seals the edge.

2. The article of claim 1, wherein the compound fills the defect.

3. The article of claim 1, wherein the edge is faceted.

4. The article of claim 1, wherein the ceramic material is monocrystalline.

5. The article of claim 1, wherein a thickness of the transparent body is no greater than 0.9 mm.

6. An article comprising:
a transparent body comprising a first layer including a first ceramic material, wherein:
the first layer first layer has a length of at least 1.1 cm, a width of at least 1.1 cm, and a thickness no greater than 1 mm;
an edge of the first layer corresponds to the thickness; and
a defect lies along or extends into the edge; and
a compound that fills the defect or seals the edge.

7. The article of claim 6, wherein the compound fills the defect and seals the edge.

8. The article of claim 6, wherein the first layer has a first major surface and a second major surface opposite the first major surface, the edge is disposed between the first and second major surfaces, and the first major surface has a first average surface roughness, and the edge has a second average surface roughness that is greater than the first roughness.

9. The article of claim 6, wherein the ceramic material includes a sapphire, a spinel, a mullite, a polycrystalline alumina, a yttria, a garnet, or any combination thereof.

10. The article of claim 6, wherein the thickness is in a range of 0.05 mm to 1 mm, 0.08 mm to 0.9 mm, or 0.11 mm to 0.7 mm.

11. The article of claim 6, wherein the article is a mobile electronic device, and wherein the transparent body is part of or covers a display of the mobile electronic device.

12. The article claim 10, wherein the mobile electronic device has a mass no greater than 2 kg, no greater than 1.4 kg, or no greater than 0.9 kg, no greater than 0.5 kg, or no greater than 0.3 kg.

13. The article of claim 6, wherein the compound includes a polyalkylether, a beta-hydroxypolyether, a polycyanoacrylate, a polyalkylacrylate, or silicon rubber.

14. The article of claim 6, wherein the ceramic material includes a sapphire, a spinel, a mullite, a polycrystalline alumina, a yttria, a garnet, or any combination thereof.

15. A method of forming an article including a transparent body, the method comprising:
grinding a first layer including a first ceramic material to form an edge that does not lie along a single plane;
applying a compound precursor solution to the edge of the first layer; and
curing the compound precursor solution to form a compound,
wherein the transparent body includes the first layer.

16. The method of claim 15, wherein the compound precursor solution has a dynamic viscosity at a temperature of 25° C. no greater than no greater than 2000 cP.

17. The method of claim 15, wherein the compound precursor solution comprises an epoxy resin, a cyanoacrylate resin, a methacrylate resin, a silicone resin, a polyol, an isocyanate, or any combination thereof.

18. The method of claim 15, further comprising annealing the first layer after grinding the first layer to form the edge and before coating the edge.

19. The method of claim 15, further comprising placing the transparent body into a mould after applying the precursor compound.

20. The method of claim 19, further comprising filling a cavity between the transparent body and the mold with a liquid or molten metal.
